(19) United States
(12) Patent Application Publication
(10) Pub. No.: US 2022/0390881 A1
(43) Pub. Date: Dec. 8, 2022

(54) INCREASING SET TEMPERATURE OF FUSER OF DRY ELECTROPHOTOGRAPHIC PRINTING DEVICE

(71) Applicant: Hewlett-Packard Development Company, L.P, Spring, TX (US)

(72) Inventor: Dean J Richtsmeier, Boise, ID (US)

(21) Appl. No.: 17/772,671

(22) PCT Filed: Dec. 20, 2019
(86) PCT No.: PCT/US2019/067808

§ 371 Date: Apr. 28, 2022

(51) Int. Cl. G03G 15/20

(52) U.S. Cl. CPC G03G 15/2039; G03G 15/2053

(57) ABSTRACT

At a specified time within a heating period during which a fuser of a dry electrophotographic (DEP) printing device is heated to a set temperature, a temperature of the fuser is measured. Responsive to determining that the measured temperature is less than a threshold temperature, the set temperature to which the fuser is heated during the heating period is increased.

### BACKGROUND

One type of printing technology by which images are formed on print media like paper is dry electrophotography (DEP), which is also referred to as xerography, and which encompasses laser printing and light-emitting diode (LED) printing technologies. A (DEP) printing device, such as a printer, multifunction device (MFD), or photocopier, selectively deposits dry toner (as opposed to liquid ink) onto print media in accordance with an image to be formed on the media. A fuser of the printing device then fuses the selectively deposited toner to the print media using heat and pressure, so that the toner adheres to the media.

### BRIEF DESCRIPTION OF THE DRAWINGS

FIG. 1 is a diagram of an example dry electrophotography (DEP) printing device,

FIG. 2 is a flowchart of an example method for satisfactorily fusing selectively deposited toner to print media regardless of the line voltage of a DEP printing device.

FIG. 3 is a diagram of an example graph in which the set temperature of a DEP printing device's fuser is increased.

FIG. 4 is a diagram of an example computer-readable data storage medium.

FIG. 5 is a block diagram of an example DEP printing device.

FIG. 6 is a flowchart of an example method.

### DETAILED DESCRIPTION

As noted in the background, a dry electrophotography (DEP) printing device selectively deposits dry toner onto print media, which a fuser of the printing device then fuses to the media so that the toner bonds to the print media. The fuser of the printing device is heated prior to advancing print media onto which toner has been selectively deposited through the fuser. If the fuser s insufficiently heated, then the fuser may not satisfactorily fuse the selectively deposited toner to the print media. As such, the toner may later flake off the print media when handled.

Some DEP printing devices have prescribed fuser heating periods in which their fusers are heated to specified set temperatures for different nominal line, or main, voltage ranges. The fuser heating process may be an open loop process. The fuser is heated to a particular set temperature for a prescribed heating period without feedback control—that is, without measuring the actual fuser temperature during or at conclusion of the heating period. Rather, for a particular nominal line voltage range, a heating period and set temperature are established beforehand, so that during subsequent usage heating the fuser to the set temperature during the heating period results in the fuser reaching the set temperature at conclusion of the period.

For each nominal line voltage range, the length of the heating period and the set temperature to which the fuser is heated during the heating period are selected so that the fuser is sufficiently heated to subsequently satisfactorily fuse selectively applied toner to print media. For example, a DEP printing device may have a specified heating period to which the fuser is heated to a particular set temperature when operating within a lower nominal line voltage range, and another specified heating period to which the fuser is heated to a different set temperature when operating at a higher nominal line voltage range. The lower nominal line voltage range may be lower than 130 volts, whereas the higher nominal line voltage range may be greater than 210 volts.

Particularly with respect to the lower nominal line voltage range, some geographic regions have main voltage that is quite a bit lower than other regions. For example, whereas most countries in North America and South America have nominal main voltage of 110 volts, 120 volts, or greater, Japan has a nominal main voltage of 100 volts. The actual line voltage in Japan can occasionally drop to lower than 90 volts for sustained periods of time. The prescribed heating period to which the fuser of a DEP printing device is heated to a particular set temperature may be inadequate for satisfactory fusing of selectively deposited toner to print media in such cases.

A seemingly intuitive solution to this problem is to introduce feedback into the fuser heating process. For instance, rather than having a prescribed heating period, the fuser of a DEP printing device may be heated until its temperature reaches the set temperature. However, it has been observed that this apparent solution is inadequate: subsequent fusing of selectively deposited toner to print media may still be unsatisfactory, and result in toner later flaking off the media when handled. The inventor has novelly determined that the problem may be that just extending the heating period of the fuser in such a dosed loop manner can still result in insufficient there al energy being imparted through the fuser for subsequent successful fusing of toner to media.

Techniques described herein ameliorate these shortcomings. At a specified time within a heating period during which the fuser of a DEP printing device is heated to a set temperature, the fuser temperature is measured. If the measured temperature is less than a threshold temperature, then the set temperature to which the fuser is heated during the heating period is increased. The fuser temperature may be monitored just once during the heating period.

The heating period may also be lengthened, such as by a set amount instead, instead of being indiscriminately extended until the fuser's actual temperature reaches a specified temperature in a true or continuous closed loop feedback manner.

Increasing the set temperature to which the fuser of a DEP printing device is heated during the heating period can impart sufficient thermal energy so that subsequent fusing of toner to media is successful. The fuser may be heated at a faster rate when its set temperature is increased. The faster heating rate can mean that more thermal energy is imparted to the fuser when increasing set temperature, as compared to just extending the heating period so that the fuser reaches the originally prescribed set temperature.

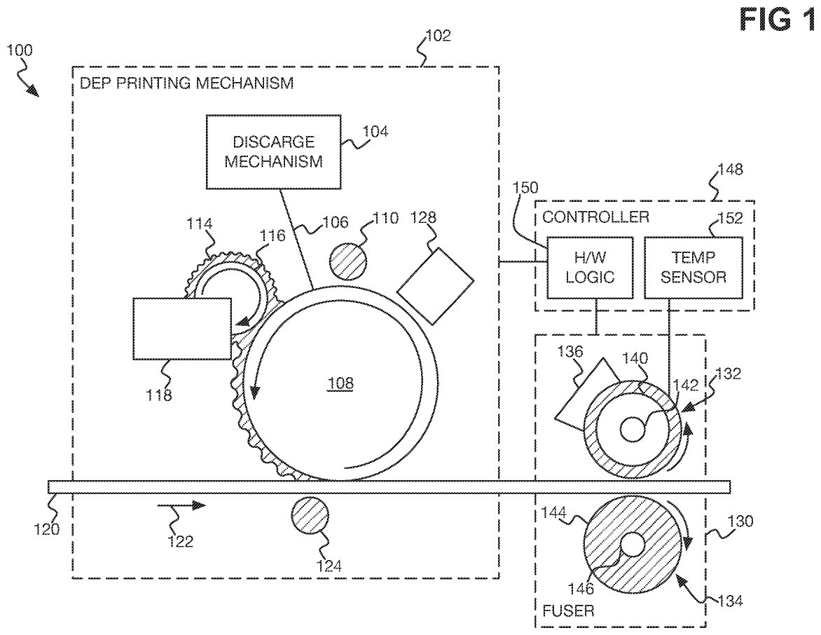

FIG. 1 shows an example DEP printing device 100 that can form images on print media 120 like paper. The printing device 100 includes an optical photoconductor (OPC) mechanism 108, which may be referred to and/or may include a photoreceptor drum, an image drum, a photoreceptor drum assembly, or a photoconductive belt. The OPC mechanism 108 can initially be given a total charge via a pre-charging mechanism 110, such as a charge roller or a charged corona wire. In another implementation, the OPC mechanism 108 may instead be initially uncharged.

As the OPC mechanism 108 rotates, such as in the counter-clockwise direction, a discharge mechanism 104 emits light 106 onto the surface of the OPC mechanism 108 to selectively discharge the OPC mechanism 108 (or selectively charge the OPC mechanism 108 if initially uncharged) in accordance with an image to be printed. The discharge mechanism 104 thus draws the image as a pattern of electrical charges, which can be referred to as an electrostatic image. The discharge mechanism 104 may include a laser source in the case of a laser printing device, or a light-emitting diode (LED) array in the case of an LED printing device.

After the pattern has been set, the image-formation device 100 coats the OPC mechanism 108 with charged dry toner 114, which may be fine powder. In monochrome printers, black toner is used; in color printers, three or more primary colors, as well as black, may be used. Because the toner 114 is charged, it clings to the discharged areas but not to the charged background of the OPC mechanism 108 (or vice-versa). A toner-application mechanism 116, like a developer roller, may dispense the toner 114 onto the OPC mechanism 108 in this manner, after first rotating through a toner hopper 118 to pick up the toner 114.

With the toner 114 loosely affixed, the OPC mechanism 108 rolls over a sheet of media 120, which may advance in the direction indicated by the arrow 122. Before the media 120 rolls under the OPC mechanism 108, it can be given a charge by a toner-transfer mechanism 124, such as a transfer charge roller or a transfer charge corona wire. The force upon the toner 114 resulting from this charge is stronger than the force holding the toner 114 to the OPC mechanism 108, so the media 120 pulls the toner 114 away from the OPC mechanism 108.

The printing device 100 finally passes the media 120 through the fuser 130. In the example of FIG. 1, the fuser 130 includes a heating roller 132, which may also be referred to as a fuse roller, and a backing roller 134, which may also be referred to as a pressure roller. As the media 120 passes between the rollers 132 and 134, which rotate in opposite directions as shown in FIG. 1, the loose toner 114 melts, flowing onto the surface of the media 120. The OPC mechanism 108 finally passes a cleaning station 128, which preparedly cleans the surface of the OPC mechanism 108 before the process that has been described is repeated.

The heating roller 132 may include a core 140 formed from a variety of different materials, such as aluminum, and that is rotatable around central axle 142. In another implementation, the core 140 may be fixed to the central axle 142, which itself is rotatable. The heating roller 132 may further include a sleeve 138 fixably surrounding the core 140, and which may be formed from rubber or another material. The backing roller 134 may include a core 144 that is also formed from rubber or another material, and rotatable about a central axle 146 or fixably attached to the central axle 146 that is itself rotatable.

The fuser 130 includes a heating element 136, which may be a resistive heating element, and which directly heats the heating roller 132. In the example of FIG. 1, the heating element 136 is externally adjacent to the heating roller 132, in thermal if not physical contact with the sleeve 138 of the roller 132, and directly heats the sleeve 138. Heat is thus directly applied to the outermost surface of the heating roller 132. In another implementation, the heating element 136 may instead be suitably positioned to generate heat from within the heating roller 132, such as through the core 140 or the central axle 142, to directly heat the roller 132. In such instance, heat conductively emanates outwards to the sleeve 132.

The backing roller 134, unlike the heating roller 132, may not be directly heated by the heating element 136. Rather, the heating element 136 may indirectly heat the backing roller 134. For instance, the heating roller 132 may conductively transfer heat from the heating element 136 to the backing roller 134. The backing roller 134 may thus not be heated as quickly as the heating roller 132. Therefore, even if the temperature of the heating roller 132 is apparently sufficient to properly fuse toner 114 to the print media 120, if insufficient thermal energy has not been transferred from the roller 132 to the backing roller 134, the toner 114 may still not properly adhere to the media 120.

The DEP printing device 100 includes a controller 148, which may include hardware logic 150 and a temperature sensor 152. The hardware logic 150 suitably controls the DEP printing mechanism 102 to selectively deposit toner 114 onto print media 120, and suitably controls the fuser 130 to fuse the selectively deposited toner 114 to the media 120. The hardware logic 150 may be implemented completely in hardware, such as an application-specific integrated circuit (ASIC), or in a combination of software and hardware, including a general purpose processor that executes program code. In either case, the hardware logic 150 is considered a non-transitory computer-readable data storage medium that stores code executable by a processor.

The temperature sensor 152 measures the temperature of the fuser 130. For instance, the temperature sensor 152 may measure the temperature of the heating roller 132, such as the outermost surface of the sleeve 138 of the roller 132. The hardware logic 150 can heat the fuser 130 to a set temperature during a heating period prior to the fuser 130 fusing selectively deposited toner 114 to the print media 120. Specifically, the hardware logic 150 can heat the fuser 130 to the set temperature during the heating period in accordance with the measured temperature of the heating roller 132.

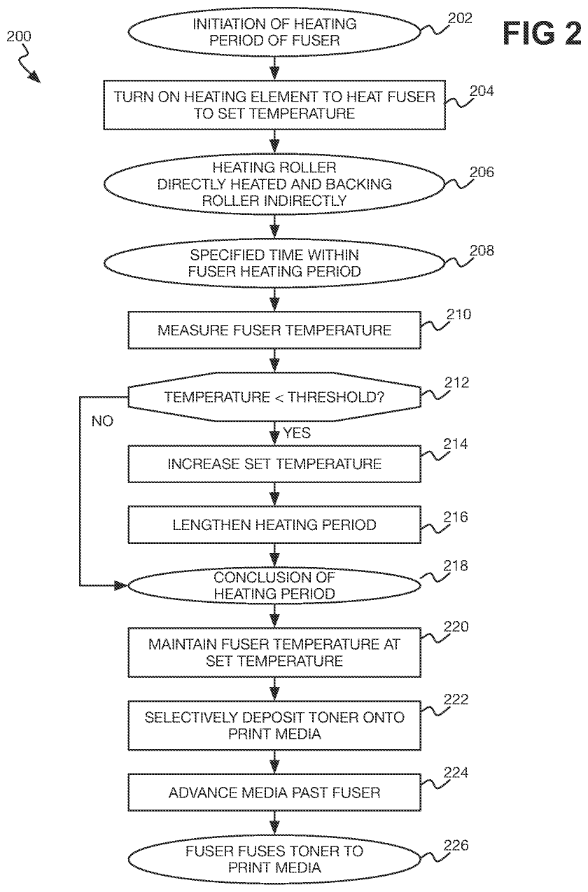

FIG. 2 shows an example method 200 for satisfactorily fusing selectively deposited toner 114 to print media 120 regardless of the line voltage of the DEP printing device 100. The method 2300 can be implemented as program code stored on a non-transitory computer-readable data storage medium and executable by the printing device 100. For instance, the hardware logic 130 of the controller 148 may perform the method 200.

The line voltage of the DEP printing device 100 is the current voltage at which the printing device 100 is powered to operate. The printing device 100 may be plugged into an electrical outlet, for instance, which is connected to main power having a nominal main voltage. While the nominal line voltage of the printing device 100 is equal to this nominal main voltage, in actuality the main voltage, and thus the line voltage, can fluctuate about the nominal voltage at any given time.

At initiation of a heating period of the fuser 130 (202), the printing device 100 turns on the heating element 136 to heat the fuser 130 to a set temperature (204). The heating element 136 may be set to the set temperature, which is the temperature to which the heating element 136 heats the fuser 130. A higher set temperature results in the heating element 136 providing the fuser assembly 130 with a higher total energy than a lower set temperature does. The heating period may be specified as the established length of time it takes, within a given tolerance, for the heating element 136 to heat the fuser 130 to a specified set temperature for a given nominal line voltage range of the printing device 100.

The heating roller 132 is directly heated by the heating element136, whereas the backing roller 134 is indirectly heated by the heating element 136 (206). At a specified time within the heating period (208)—i.e,, at a specified time after the start of the heating period—the printing device 100 measures the temperature of the fuser 130 (210). For instance, the temperature sensor 152 of the controller 148 may measure the temperature of the heating roller 132, such as the outermost surface of the roller 132. Because the heating roller 132 is directly heated whereas the backing roller 134 is indirectly heated, the heating roller 132 will reach a given temperature before the backing roller 134 does.

If the measured temperature of the fuser 130 is less than a threshold temperature (212), then the printing device 100 increases the set temperature to which the heating element 136 heats the fuser 130 (214). Therefore, for a given heating period, more thermal energy is imparted to the backing roller 134 that is indirectly heated via thermal conduction through the heating roller 132. The printing device 100 may also lengthen the heating period (216).

The amount to which or by which the set temperature is increased, as well as the time to which or by which the heating period may be lengthened, may be determined in a variety of different ways. The hardware logic 150 of the controller 148 may reference a lookup table that provides the increased set temperature and/or the lengthened heating period for a given measured temperature of the fuser 130. As another example, the hardware logic 150 may perform a calculation to determine the increased set temperature and/or the lengthened heating period, as a function of the measured temperature.

If the measured temperature of the fuser 130 is not less than the threshold temperature (212), then the set temperature is not increased and the heating period is not lengthened. That is, the heating element 136 heats the fuser 130 to the original, non-increased set temperature by the end of the original, non-lengthened heating period, The lengthened or non-lengthened heating period thus concludes (218), with the fuser 130 at the increased or non-increased set temperature.

Once the heating period has elapsed, the printing device 100 then maintains the fuser 130 at the set temperature (220), That is, the heating element 136 continues to heat the fuser 130 not to increase its temperature, but to maintain the fuser 130 at the set temperature. The printing mechanism 102 of the printing device 100 selectively deposits toner 114 onto the print media 120 in accordance with an image to be formed on the media 120 (222). As the print media 120 is advanced past (e.g., through) the fuser 130 (224), the fuser 130 fuses the selectively deposited toner 114 to the media 120 (226).

The threshold temperature to which the measured temperature of the fuser 130 is compared in part 212 can be selected to correspond to the expected temperature of the fuser 130 for a given nominal line voltage of the printing device 100. That is, the threshold temperature is the expected minimum temperature to which the heating element 136 has heated the fuser 130 at the specified time within the heating period when the printing device 100 operates at a given line voltage. If the measured temperature of the fuser 130 is too low, then the printing device 100 may be operating at a lower line voltage insufficient to heat the fuser 130 during the heating period to result in subsequent satisfactory fusing of toner 114 to print media 120.

In such instance, increasing the set temperature results in the fuser 130 being sufficiently heated during the heating period to subsequently satisfactorily fuse toner 114 to print media 120. Sufficient thermal energy will therefore be imparted throughout the fuser 130 to permit subsequent satisfactory fusing. By comparison, just lengthening the heating period so that the fuser 130 reaches the originally prescribed set temperature at the end of the lengthened heating period may not result in sufficient thermal energy being imparted throughout the fuser 130 to provide for subsequent satisfactory fusing.

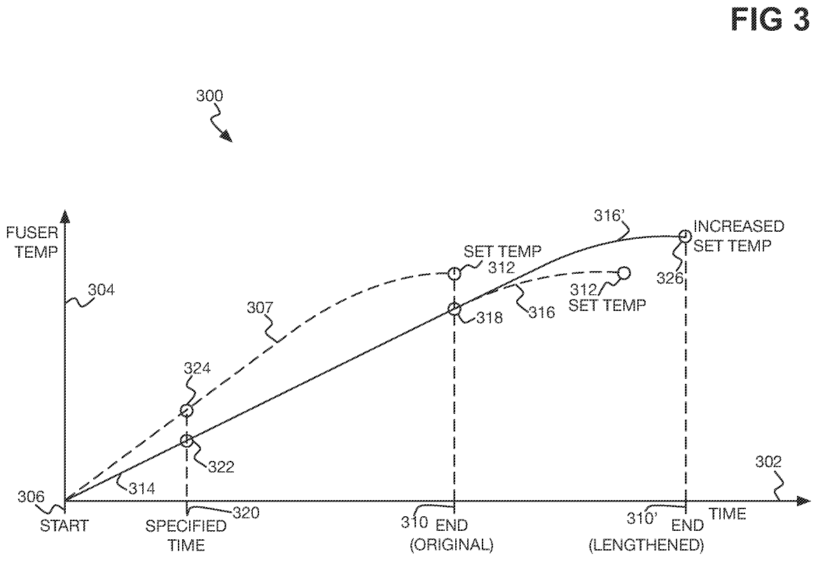

FIG. 3 shows an example graph 300 in which the set temperature of the fuser 130 of the printing device 100 may be increased during the heating period, with or without also lengthening the heating period itself. The x-axis 302 denotes time, whereas the y-axis 304 denotes fuser temperature. If the line voltage of the printing device 100 is at the expected nominal voltage, the temperature of the fuser 130 may conform to the dotted line 307. The fuser temperature increases from the start 306 of the heating period, reaches the temperature 324 at the specified time 320 within the heating period, and may reach the set temperature 312 at the end 310 of the heating period.

However, if the line voltage of the printing device 100 is sufficiently lower than the expected nominal voltage, the temperature of the fuser 130 may conform to the line 314. The fuser temperature increases at a slower rate from the start 306 of the heating period, and thus reaches a lower temperature 322 at the specified time 320 within the heating period. The fuser temperature continues to more slowly increase, until at the end 310 of the heating period it reaches a temperature 318 lower than the originally specified set temperature 312. The fuser temperature may not reach the set temperature 312 until some time after end 310 of the heating period, per the dotted line 316.

In accordance with the method 200, however, the measured temperature 322 of the fuser 130 at the specified time 320 within the heating period is compared to a threshold temperature, which may be the temperature 324 the fuser 130 would have reached at the nominal line voltage, plus or minus a margin of error. Because the temperature 322 is less than the threshold temperature, the set temperature 312 is increased to the increased set temperature 326. Therefore, past the original end 310 of the heating period, the fuser temperature increases at a faster rate, per the line 316′. The fuser 130 is heated to the increased set temperature 326 at the end 310′ of the (lengthened) heating period.

Sufficient thermal energy is thus imparted to the fuser 130 to subsequently result in satisfactory fusing of toner 114 to print media 120. Increasing the set temperature of the fuser 130 compensates for decreased line voltage of the printing device 100 by increasing the total amount of thermal energy imparted to the fuser 130. For nstance, increasing the set temperature can increase the total amount of thermal energy transferred to the backing roller 134 during the (lengthened) heating period.

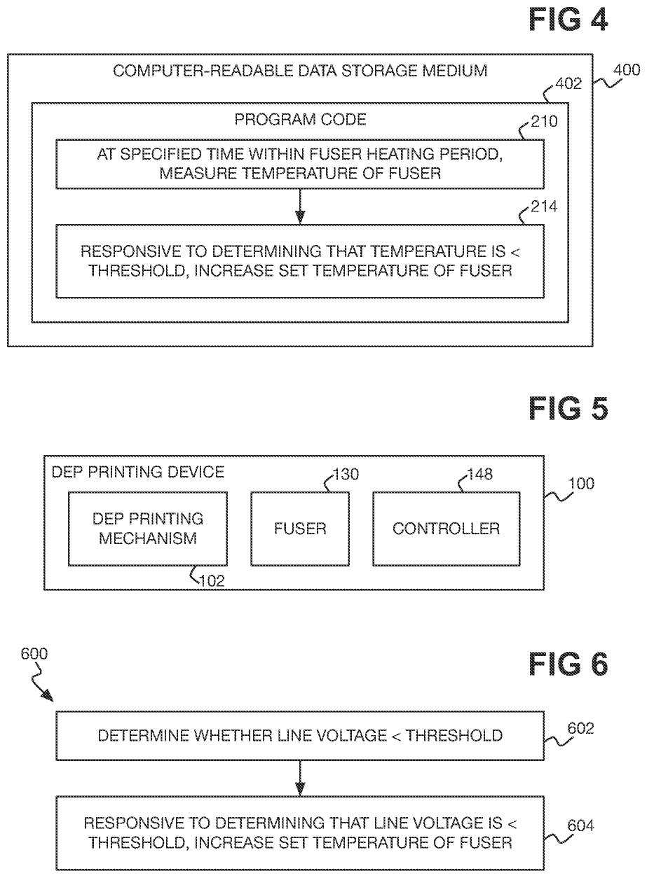

FIG. 4 shows an example non-transitory computer-readable data storage medium 400. The computer-readable data storage medium 400 stores program code 402 executable by the DEP printing device 100 to perform processing. The processing includes, at a specified time within a heating period during which a fuser 130 of the printing device 100 is heated to a set temperature, measuring a temperature of the fuser (210). The processing further includes, responsive to determining that the measured temperature is less than a threshold temperature, increasing the set temperature to which the fuser 130 is heated during the heating period (214).

FIG. 5 shows an example DEP printing device 100. The printing device 100 includes the DEP printing mechanism 102, the fuser 130, and the controller 148. The printing mechanism selectively deposits toner 114 onto print media 120. The fuser 130 fuses the selectively deposited toner 114 to the print media 120. The controller 148 can maintain a total amount of thermal energy that is imparted to the fuser 130 during the heating period, regardless of the line voltage of the printing device 100. For instance, the controller 148 can ensure that the total amount of thermal energy imparted to the fuser 130 during the heating period is sufficient to subsequently adequately fuse the toner 114 onto the media 120, even if the line voltage of the printing device 100 is lower than an expected nominal line voltage,

The controller 148 maintains the total amount of thermal energy imparted to the fuser 130 in this manner by increasing the set temperature to which the fuser 130 is heated during the heating period. The controller increases the set temperature responsive to the temperature of the fuser 130 measured at a specified time within the heating period being less than a threshold temperature. The controller 148 may therefore maintain the temperature to which the backing roller 134 of the fuser 130 is indirectly heated at completion of the heating period regardless of the line voltage of the printing device 100, and without the temperature of the backing roller 134 actually being measured.

FIG. 6 shows an example method 600. The method 600 includes determining whether a line voltage of a DEP printing device 100 is less than a threshold voltage (602). For instance, this determination may be indirectly achieved by measuring the temperature of the fuser 130 of the printing device 100 and determining whether the measured temperature is less than a threshold temperature. The method 600 includes, responsive to determining that the line voltage is less than the threshold voltage, increasing a set temperature to which the fuser 130 is heated prior to fusing selectively deposited toner 114 to print media 120 advancing past the fuser 130 (604). The heating period itself may also be lengthened,

Techniques have been described herein to ensure that sufficient thermal energy is imparted through the fuser of a DEP printing device during the heating period of the fuser so that subsequent fusing of toner to print media is successful. A printing device that may not otherwise be able to be used (and thus sold) in geographic regions having relatively low line, or main, voltage can thus be used in such regions. In the techniques that have been described, the set temperature to which the fuser of the printing device is heated during the heated period is increased, in addition to or in lieu of lengthening the heating period itself.

We claim:

1. A non-transitory computer-readable data storage medium storing program code executable by a dry eiectrophotographic (DEP) printing device to perform processing comprising:
at a specified time within a heating period during which a fuser of the DEP printing device is heated to a set temperature, measuring a temperature of the fuser; and
responsive to determining that the measured temperature is less than a threshold temperature, increasing the set temperature to which the fuser is heated during the heating period.

2. The non-transitory computer-readable data storage medium of claim 1, wherein increasing the set temperature to which the fuser is heated during the heating period compensates for a decreased line voltage of the DEP printer device.

3. The non-transitory computer-readable data storage medium of claim 1, wherein the processing further comprises:
responsive to determining that the measured temperature is less than the threshold temperature, lengthening the heating period during which the fuser is heated to the increased set temperature.

4. The method of claim 3, wherein increasing the set temperature to which the fuser is heated in addition to lengthening the heating period increases a total amount of thermal energy imparted to the fuser more than just lengthening the heating period without increasing the set temperature does.

5. The non-transitory computer-readable data storage medium of claim 1, wherein the processing further comprises:
after the heating period has elapsed, advancing print media onto which toner has been selectively deposited past the fuser,
wherein the fuser fuses the selectively deposited toner to the print media,

6. The method of claim 5, wherein increasing the set temperature to which the fuser is heated ensures that the toner is satisfactorily fused to the print media after having been advanced past the fuser,

7. The non-transitory computer-readable data storage medium of claim 1, wherein the processing further comprises:
at initiation of the heating period, turning on a heating element of the fuser, the heating element directly heating a heating roller of the fuser,
wherein the heating element indirectly heats a backing roller of the fuser positioned opposite the backing roller, via thermal conduction through the heating roller,

8. The non-transitory computer-readable data storage medium of claim 7, wherein the processing further comprises:
at completion of the heating period, maintaining a temperature of the fuser at the set temperature.

9. The non-transitory computer-readable data storage medium of claim 8, wherein increasing the set temperature to which the fuser is heated increases a total amount of thermal energy transferred to the backing roller more than just lengthening the heating period without increasing the set temperature does.

10. A dry electrophotographic (DEP) printing device comprising:
a DEP printing mechanism to selectively deposit toner onto print media;
a fuser to fuse the selectively deposited toner to the print media; and
a controller to maintain a total amount of thermal energy imparted to the fuser during a heating period regardless of a line voltage of the DEP printing device.

11. The DEP printing device of claim 10, wherein the controller is to maintain the total amount of thermal energy imparted to the fuser during the heating period regardless of the line voltage by increasing a set temperature to which the fuser is heated during the heating period responsive to a temperature of the fuser measured at a specified time within the heating period being less than a threshold temperature.

12. The DEP printing device of claim 11, wherein the fuser comprises:
a heating element;
a heating roller directly heated by the heating element; and
a backing roller opposite the heating roller and indirectly heated by the heating element via thermal conduction through the heating roller.

13. The DEP printing device of claim 12, wherein the controller is to maintain a temperature to which the backing roller is indirectly heated at completion of the heating period regardless of the line voltage of the DEP printing device, and without the temperature of the backing roller being measured.

14. A method comprising:
determining whether a line voltage of a dry electrophotographic (DEP) printing device is less than a threshold voltage; and
responsive to determining that the line voltage is less than the threshold voltage, increasing a set temperature to which a fuser of the DEP printing device is heated prior to fusing selectively deposited toner to print media advancing past the fuser.

15. The method of claim 14, wherein a heating period in which the fuser s heated to the increased set temperature is also increased responsive to determining that the line voltage is less than the threshold voltage.
